(19) United States
(12) Patent Application Publication
(10) Pub. No.: US 2012/0176035 A1
(43) Pub. Date: Jul. 12, 2012

(54) LIGHTING ASSEMBLY

(76) Inventors: Michael J. Alloway, Canton, MI (US); Justin Tungjunyatham, Roseville, MN (US)

(21) Appl. No.: 13/497,460

(22) PCT Filed: Sep. 23, 2010
(86) PCT No.: PCT/US2010/049970

§ 371 Date: Mar. 21, 2012

Related U.S. Application Data
(60) Provisional application No. 61/245,026, filed on Sep. 23, 2009.

(51) Int. Cl. B60Q 1/44; H05B 37/02

(52) U.S. Cl. 315/77; 315/192

(57) ABSTRACT

Lighting assemblies having an electrical cable, light emitting diodes, and control circuits. The lighting assemblies are useful, for example in vehicles (e.g., automobile, trucks, etc.), as well as task lighting accent lighting, merchandise display lighting, and back lighting applications.

### BACKGROUND

Light emitting diodes (“LEDs”) are widely used in a variety of sign, message board, and light source applications. The relatively high efficacy of LEDs (in lumens per watt) is typically the primary reason for their use. Large power savings are possible when LED signals are used to replace traditional incandescent signals of similar luminous output.

It is desirable to have uniform LED junction temperature on the LEDS along the light string, particularly for a relative long string (e.g., lengths over 3 meters or more) of LEDs. This can be advantageous for several reasons. First the life of an LED is inversely related to junction temperature. Secondly, light output degradation is related to junction temperature. For two LEDs driven at like power levels, the LED with the lower junction temperature will emit higher levels of light output measured in lumens.

LEDs being semi-conductor devices, contain a property know as forward voltage bias required to turn the LED on. These bias voltages sum for LEDs in series along the cable which dictates the drive voltage required to power the string. In order to maintain a reasonable operating voltage, 24 volts or less, the LEDs are arranged in series parallel groups along the length of the light string.

Optimum thermal and lumen output occurs when the voltage drop across each parallel group is equivalent. A flat cable, for example, having electrical conductors has inherent resistances which will result in parasitic voltage losses along the run of the LED string, with the LED groups at the end of the cable nearer to the power supply experiencing higher voltages and the LED groups at the far end of the LED string experiencing lower voltages. The result being that the earlier LEDs experience greater then the design intent voltages and thus heating and reduced life and lumen output, and the LEDs at the far end of the string experiencing lower then design intend voltage and resulting reduced lumen output.

### SUMMARY

In one aspect, the present disclosure describes a lighting assembly comprising:
a flexible cable having a length and comprising electrical conductors to provide electrical circuit paths;
a first electrical group comprising:
   at least one of a first electrical resistor or a first diode, a first light emitting diode, and a control circuit electrically connected sequentially in series; and
   a second electrical group comprising:
      a first light emitting diode and a control circuit electrically connected sequentially in series;
wherein the first and second electrical groups are electrically connected in parallel to electrical connectors of the flexible cable, and wherein when the light assembly is energized, the first light emitting diode of the first electrical group and the first light emitting diode of the second electrical group exhibit draw the same level of power (i.e., +/−2% of the average the two electrical groups if each of the first and second groups were separately connected to a power source having the same voltage).
   Optionally, the lighting assembly is flexible.

Optionally, the first electrical group further comprises a second (one, two, three, four, five, sixth, seven, eight, nine, ten, or more) additional light emitting diode(s) electrically connected sequentially in series between the first light emitting diode and the control circuit of the first electrical group, wherein the second electrical group further comprises a second (one, two, three, four, five, sixth, seven, eight, nine, ten, or more) additional light emitting diode(s) electrically connected sequentially in series between the first light emitting diode and the control circuit of the second electrical group, and wherein when the light assembly is energized, the light emitting diodes exhibit draw the same level of power.

Optionally, the lighting assembly further comprises additional (i.e., one, two, three, four, five, sixth, seven, eight, nine, ten, or more) electrical groups as described for the second electrical group, which may include an additional light emitting diode(s) (i.e., one, two, three, four, five, sixth, seven, eight, nine, ten, or more) as described above.

In this application:

“Flexible” means the lighting assembly or cable, as applicable, can be wrapper around a 5 mm diameter rod without breaking or damaging the lighting function of the lighting assembly or cable, as applicable.

In some embodiments, and typically desirably, the light emitting diodes, when energized have a uniform lumens output. In some embodiments, lighting assemblies described herein have a total power usage of up to 1 watt, 0.75 watt, or even 0.5 watt, wherein lower wattages are typically more desirable.

Light assemblies described herein are useful, for example, in vehicles (e.g., automobile, trucks, etc.), as well as, task lighting accent lighting, merchandise display lighting, and back lighting applications. Useful embodiments of light assemblies described herein for vehicles include as a brake center light.

### BRIEF DESCRIPTION OF THE DRAWINGS

FIG. 1A is a top view of an exemplary flexible lighting assembly described here.

FIG. 1B is a cutaway side view of part of the exemplary flexible lighting assembly shown in FIG. 1A.

FIG. 1C is a cross-sectional end view of the flexible cable shown in FIGS. 1A and 1B.

FIG. 1D is an electrical diagram.

### DETAILED DESCRIPTION

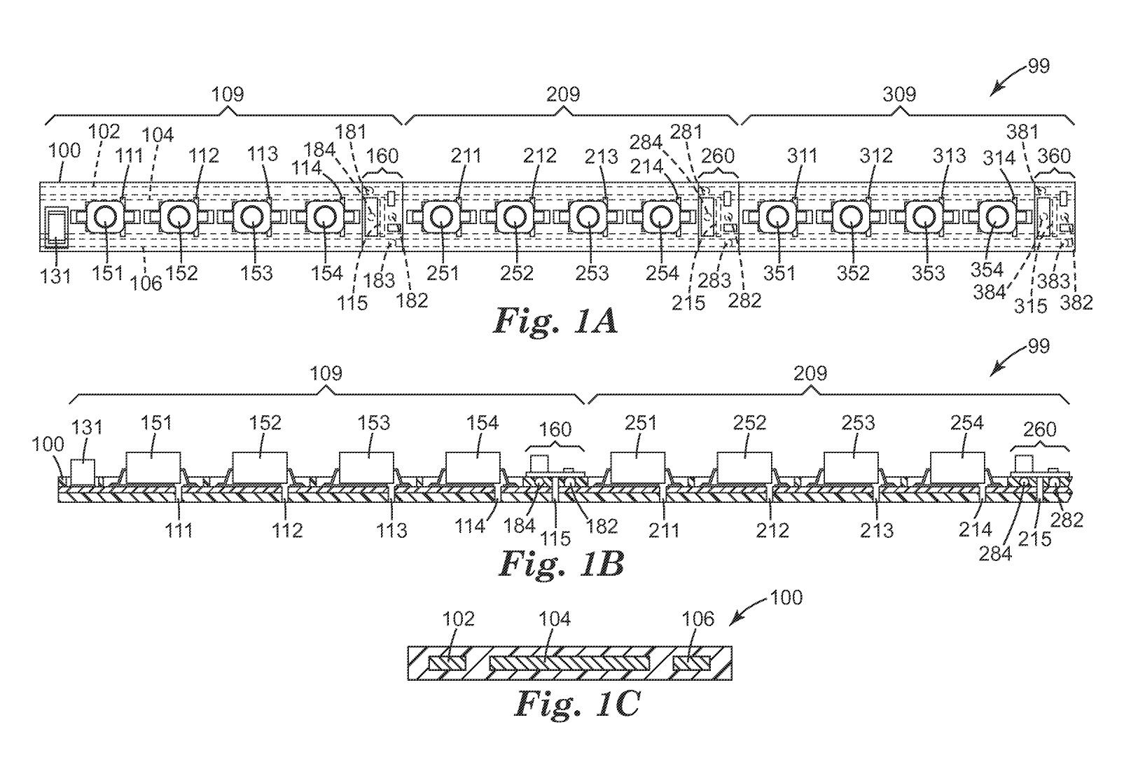

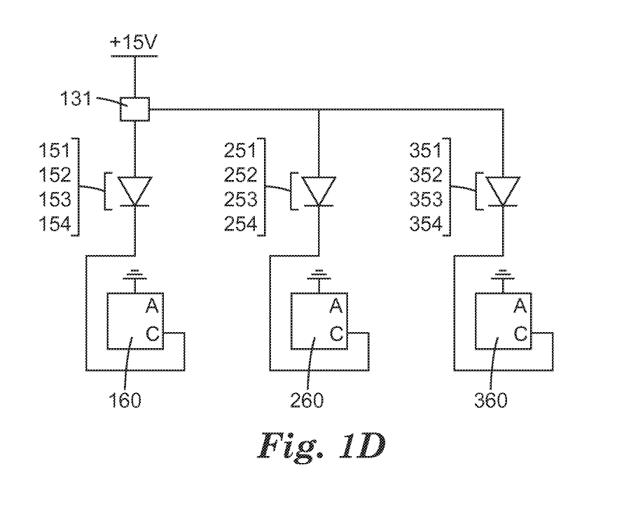

Referring to FIGS. 1A, 1B, and 1C, exemplary lighting assembly 99 has electrical cable 100 having electrical conductors 102, 104, 106, solder bumps 181, 182, 183, 184, 281, 282, 283, 284, 381, 382, 383, 384, and cutouts 111, 112, 113, 114, 115, 211, 212, 213, 214, 215, 311, 312, 313, 314, 315 to provide electrical circuit paths, and first, second, and optional third electrical groups 109, 209, 309, respectively, electrically connected in parallel to electrical cable 100. First electrical group 109 has (zero ohm) electrical resistor 131, light emitting diode 151, optional light emitting diodes 152, 153, 154, and control circuit 160, 260 electrically connected sequentially in series. Second electrical group 209 has light emitting diode 251, optional light emitting diodes 252, 253, 254, and control circuit 260 electrically connected sequentially in series. Third electrical group 309 has light emitting diode 351, optional light emitting diodes 352, 353, 354, and control circuit 360 electrically connected sequentially in series. Although not shown, as is known in the art, optionally a rectifier is used to protect or ensure power bias.

Further, FIG. 1D shows the electrically circuitry of for exemplary lighting assembly 99, which includes a 15 V power source (as shown), Schottky diode or zero ohm resistor 131, and light emitting diode 151, optional light emitting diodes 152, 153, 154, and control circuit 160 electrically connected sequentially in series, and in turn in parallel to light emitting diode 251, optional light emitting diodes 252, 253, 254, and control circuit 260 electrically connected sequentially in series, and in turn in parallel to light emitting diode 351, optional light emitting diodes 352, 353, 354, and control circuit 360 electrically connected sequentially in series. Further “C” designates the LED current sync pin, and “A” designates the LED bias protection pin. The respective light emitting diode is connected to the cathode of the respective control circuit. Although not wanting to be bound by theory, it is believed it is advantageous to connect to the LED current sync pin (C) of the control circuit and use a Schottky diode or zero ohm resistor (131) for bias protection rather than use the LED bias protection pin (A). Further, although not wanting to be bound by theory, it is believed that this arrangement prevents temperature feedback from the LED to the control circuit and affecting the ambient temperature measuring monitor within the control circuit.

Suitable flexible cables are known in the art, and include those marketed by Parlex USA, Methuen; Leoni AG, Nuremburg, Germany; and Axon' Cable S.A.S., Montmirail, France.

Exemplary widths of the electrical cable range from 10 mm to 30 mm. Exemplary thicknesses of the electrical cable range from 0.4 mm to 0.7 mm.

Suitable light emitting diodes are known in the art, and commercially available. LEDs are available in a variety of power usage ratings, including those ranging from less than 0.1 to 5 watts (e.g., power usage ratings up to 0.1, 0.25, 0.5, 0.75, 1, 1.25, 1.5, 1.75, 2, 2.5, 3, 4, or even up to 5 watts) per LED. LEDs are available in colors ranging range from violet (about 410 nm) to deep red (about 700 nm). A variety of LED colors are available, including white, blue, green, red, amber, etc.

In some embodiments of light assemblies described herein, the distance between LEDs may be at least 50 mm, 100 mm, 150 mm, 200 mm, or even at least 250 mm or more.

In some embodiments of light assemblies described herein have at least 2, 3, 4, or even at least 5, light emitting diodes per length of, for example, 300 mm.

Suitable resistors are known in the art, and are typically current sense resistors, which generally less than 10 ohms.

A control circuit regulates the current to the LED(s) preceding it, and well as provides power to any subsequent LED(s) in the circuit. Typically, the control circuit(s) includes an associated sense resistor for current level selection. In some embodiments, the control circuit(s) include a temperature monitoring function (e.g., the control circuit(s) include an LED current regulator, a trim potentiometer, and a resistor to set the thermal monitor threshold where the output current starts to be reduced with increasing temperature. Control circuits can be made by one skilled in the art usually conventional circuitry components and techniques.

In some embodiments of light assemblies described herein have at least 3, 4, or even at least 5, light emitting diodes per length of, for example, 300 mm.

Suitable light assembly configurations can be designed and assembled using known techniques by one skilled in the art after reviewing the instant disclosure.

Preferably, the circuit board with control circuit and the flat flexible cable are electrically connected via an electrical connection protrusion(s) (e.g., a solder bump(s)), including an electrical connection protrusion made of a first metal composition having a first melting point, having an exposed outer surface, and being present on the circuit board, and a second metal composition having a second melting point, lower than the first melting point, being disposed around the remaining exposed outer surface of the protrusion, wherein there is a distinct line of demarcation between the protrusion and the second metal composition.

One skilled in the art can select the appropriate first and second metal compositions (typically solders) having the desired melting and flow characteristics.

The circuit board with control circuit and the flat flexible cable can be electrically connected via electrical connection protrusion (s) (e.g., solder bump(s)), for example, by providing a circuit board having an electrical connection protrusion(s) made of a first metal composition having a first melting point and an exposed outer surface; providing a flat flex cable with an electrical contact; placing the electrical contact in direct contact with a portion of the outer exposed surface of the protrusion(s), leaving a remaining outer exposed surface of the protrusion(s); providing a second solder composition having a second melting point, lower than the first melting point; heating the second solder composition to provide a melt that is disposed around the remaining exposed outer surface of the protrusion(s) without melting the first metal composition; and cooling the melt disposed around the remaining exposed outer surface of the protrusion(s).

It may be desirable for some applications to linearly connect, in electrically series, 2, 3, 4, 5, or more light assemblies as described herein to provide light over long distances.

Light assemblies described herein are useful, for example, in vehicles (e.g., automobile, trucks, etc.), as well as, task lighting accent lighting, merchandise display lighting, and back lighting applications. Useful embodiments of light assemblies described herein for vehicles include as a brake center light.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLE

A lighting assembly was constructed as generally shown in FIGS. 1A-1D. A flat flexible cable was made by conventional techniques by drawing three rectangular copper conductors side-by-side through a pull-through die and encapsulating the three conductors with a TPE-E type insulation having a Shore D hardness of 72. The resulting flat flexible cable was 13.5 mm in width with the conductors arranged as shown in FIG. 1C. Two outer conductors (0.2 mm thick by 1.54 mm in width) were each located 0.9 mm from each edge of the cable. A center conductor (0.2 mm thick by 6.6 mm in width) was positioned between the two outer conductors with a separation of 1 mm from the two outer conductors. The total thickness of the cable was 0.55 mm.

A Class IV CO2 laser was used to make cut-outs and remove insulation from the flat flexible cable, and thereby facilitating proper electrical contact for the resistors, LEDs and control circuits. A series of three electrically parallel groups of LEDs and control circuits were surface mounted onto the cable and electrically connected to the conductor below via the cut-outs. Each group consisted of four LED's (obtained under the trade designation “LCW W5AM” from Osram-Sylvania, Danvers, Mass.) followed by a control circuit. The control circuit consisted of the following components: an LED current regulator (obtained under the trade designation “A6260” from Allegro Microsystems, Worcester, Mass.), an associated sense resistor (obtained under the trade designation “0805”) for current level selection, a trim potentiometer, and a resistor to set the thermal monitor threshold where the output current starts to be reduced with increasing temperature.

The components were mounted onto a FR4 copper circuit board with 2 ounce copper. A maximum copper etch was utilized. The LEDs and control circuits were hand soldered to the cable using a conventional tin-lead solder paste. The circuit board with the control circuits and the flat flexible cable were electrically connected via solder bumps. Four tin-silver-copper solder bumps (1.3 mm (0.05 inch) diameter, 0.64 mm (0.025 inch) height) made of solder obtained under the trade designation “NC254” from Aim Solder, Cranston, R.I.) were provided on the control circuits. These solder bumps had exposed outer surfaces. The electrical contacts of the flat flex cable were placed in direct contact with a portion of the respective outer exposed surfaces of the solder bumps, leaving a remaining outer exposed surface of the solder bump. A second, bismuth-tin solder (made of solder obtained under the trade designation “INDALLOY #281” from Indium Corporation of America, Utica, N.Y.) was heated to provide a melt that was disposed around the remaining exposed outer surface of the solder bump without melting the first solder, and then cooled.

The first group was constructed with a schottky diode (obtained under the trade designation “MBRS360T3G” from ON Semiconductor, Phoenix, Ariz.) positioned to bridge the outer conductor (power supply) and the center conductor of the cable. The first LED within a group was positioned with its anode electrically connected to the schottky diode. The second, third and fourth LEDs were positioned with their anodes biased to the higher potential. The control circuit was positioned on the cable such that it was electrically connected to the cathode of the fourth LED. The control circuit regulates the current in a group and provides the power connection (bridge) from the power conductor to the anode of the first LED in the next group via the center conductor, and bridged from the center conductor and the outer conductor (ground potential).

The spacing between the first resistor and first LED in the first group was about 100 mm. The spacing between each LED within a group was about 110 mm. The spacing between the last LED in the group and the control circuit was about 60 mm. The spacing between the control circuit and the first LED in the next group was about 100 mm. An additional cut-out was made through the center conductor using a conventional punch tool in a hand operated press, in between each group to interrupt electrical current flow and provide series-parallel electrical circuits in the flat flexible cable. To provide power to the lighting assembly, one of the outer conductors was connected to a positive power supply potential and the other outer conductor being connected to a ground potential.

### Test Method

The lighting assembly was tested for power uniformity. A 15 volt laboratory power supply was connected to the light assembly. The lighting assembly was allowed to stabilize for 30 minutes after start-up. A copper (22 AWG) wire, about 70 mm in length, was used to jump from the control circuit board cathode connection to the cathodes of the fourth LED in the groups. The jumper wire was constructed so as to provide a separable connection via wire terminals. A multi-meter (obtained from Fluke, Everett, Wash.) was connected in series between the cathode of the fourth LED and the control circuit board in the first group to measure current flow. The current reading was 306 milliamperes. The jumper for the first group was re-connected and the multi-meter was then connected in series between the cathode of the fourth LED and the control circuit board in the second group to measure current flow. The current reading was 310 milliamperes. The jumper for the second group was re-connected and the multi-meter was then connected in series between the cathode of the fourth LED and the control circuit board in the third group to measure current flow. The current reading was 307 milliamperes. The percentile difference between the high and low current readings was 1.3% indicating a high level of current uniformity which directly leads to more uniform LED power, which resulted in more uniform lumen output among all the LEDs in the example lighting assembly.

Foreseeable modifications and alterations of this invention will be apparent to those skilled in the art without departing from the scope and spirit of this invention. This invention should not be restricted to the embodiments that are set forth in this application for illustrative purposes.

1. A flexible lighting assembly comprising:
a flexible cable having a length and comprising electrical conductors to provide electrical circuit paths;
a first electrical group comprising:
at least one of a first electrical resistor or a first diode, a first light emitting diode, and a control circuit electrically connected sequentially in series; and
a second electrical group comprising:
a first light emitting diode and a control circuit electrically connected sequentially in series;
wherein the first and second electrical groups are electrically connected in parallel to electrical connectors of the flexible cable, and wherein when the light assembly is energized, the first light emitting diode of the first electrical group and the first light emitting diode of the second electrical group draw the same level of power.

2. The light assembly according to claim 1, wherein the first electrical group further comprises a second light emitting diode electrically connected sequentially in series between the first light emitting diode and the control circuit of the first electrical group, wherein the second electrical group further comprises a second light emitting diode electrically connected sequentially in series between the first light emitting diode and the control circuit of the second electrical group, and wherein when the light assembly is energized, the light emitting diodes draw the same level of power.

3. The light assembly according to claim 1, wherein the first electrical group further comprises a second light emitting diode and a third light emitting diode electrically connected in said order sequentially in series between the first light emitting diode and the control circuit of the first electrical group, wherein the second electrical group further comprises a second light emitting diode and a third light emitting diode electrically connected in said order electrically connected sequentially in series between the first light emitting diode and the control circuit of the second electrical group, and wherein when the light assembly is energized, the light emitting diodes draw the same level of power.

4. The light assembly according to claim 1, wherein the first electrical group further comprises a second light emitting diode, a third light emitting diode, and a fourth light emitting diode electrically connected in said order sequentially in series between the first light emitting diode and the control circuit of the first electrical group, wherein the second electrical group further comprises a second light emitting diode, a third light emitting diode, and a fourth light emitting diode electrically connected in said order electrically connected sequentially in series between the first light emitting diode and the control circuit of the second electrical group, and wherein when the light assembly is energized, the light emitting diodes draw the same level of power.

5. The light assembly according to claim 1, wherein the first electrical group further comprises a second light emitting diode, a third light emitting diode, a fourth light emitting diode, a fifth light emitting diode electrically connected in said order sequentially in series between the first light emitting diode and the control circuit of the first electrical group, wherein the second electrical group further comprises a second light emitting diode, a third light emitting diode, a fourth light emitting diode, and a fifth light emitting diode electrically connected in said order electrically connected sequentially in series between the first light emitting diode and the control circuit of the second electrical group, and wherein when the light assembly is energized, the light emitting diodes draw the same level of power.

6. The lighting assembly according to claim 1, wherein the light emitting diodes each have a power usage rating up to 2 watts, 1.5 watts, 1.25 watts, 1.1 watts, or 1 watt.

7. (canceled)

8. (canceled)

9. (canceled)

10. (canceled)

11. The lighting assembly according to claim 1 having at least 2 light emitting diodes per length of at least 300 cm.

12. The lighting assembly according to claim 1, wherein the control circuits include a temperature monitoring function.

13. A plurality of lighting assemblies according to claim 1 linearly connected electrically in series.

14. A vehicle comprising the flexible lighting assembly according to claim 1.

15. The vehicle according to claim 15, wherein the flexible lighting assembly is a brake center light.

16. The vehicle according to claim 15, which is an automobile or a truck.

17. The lighting assembly according to claim 1, which is task lighting.

18. The light assembly according to claim 1, wherein at least one control circuit comprises an LED current regulator, a trim potentiometer, and a resistor to set the thermal monitor threshold where the output current starts to be reduced with increasing temperature.

19. The light assembly according to claim 18, wherein the at least one control circuit further comprises an associated sense resistor for current level selection.

20. The light assembly according to claim 1, wherein the control circuit of the first electrical group regulates the current to the light emitting diode preceding it and provides power to any subsequent light emitting diode electrically connected thereto.

21. The light assembly according to claim 20, wherein the control circuit of the first electrical group comprises an associated sense resistor for current level selection.

22. The light assembly according to claim 1, wherein at least one of the control circuits comprises a circuit board that is electrically connected to the flexible cable via at least one electrical connection protrusion in the form of a solder bump made of a first metal composition having a first melting point, having an exposed outer surface, and being present on the circuit board, and a second metal composition having a second melting point, lower than the first melting point, being disposed around the remaining exposed outer surface of the protrusion, wherein there is a distinct line of demarcation between the protrusion and the second metal composition.
